(19) United States
(12) Patent Application Publication
(10) Pub. No.: US 2023/0367184 A1
(43) Pub. Date: Nov. 16, 2023

(54) LENS UNIT AND CAMERA MODULE

(71) Applicant: Maxell, Ltd., Kyoto (JP)

(72) Inventor: Akira INABA, Kyoto (JP)

(73) Assignee: Maxell, Ltd., Kyoto (JP)

(21) Appl. No.: 18/029,108

(22) PCT Filed: Sep. 16, 2021
(86) PCT No.: PCT/JP2021/034044

§ 371 Date: Mar. 29, 2023

(30) Foreign Application Priority Data
Oct. 1, 2020 (JP) 2020-166963

(51) Int. Cl. G03B 17/12; G02B 7/02

(52) U.S. Cl. CPC G03B 17/12; G02B 7/025

(57) ABSTRACT

A lens unit and a camera module are provided capable of reliably waterproofing a lens space between a first lens and a second lens without use of an O-ring, preventing a back surface of the first lens from becoming fogged, and preventing degradation of optical performance.

Among the plurality of lenses, a first lens 13, which is located closest to the object side, and a second lens 14, which is adjacent to the first lens 13 on an image side, are bonded together to be waterproofed with a low-moisture permeable adhesive ad, so that a space between the first lens and the lens barrel can be reliably waterproofed without use of the O-ring, the back surface of the first lens can be prevented from becoming fogged, and optical performance can be prevented from degrading.

### TECHNICAL FIELD

The present invention relates to a lens unit and a camera module capable of constituting an in-vehicle camera to be mounted on a vehicle such as an automobile.

### BACKGROUND ART

A technique is known in which a camera (in-vehicle camera) mounted on a vehicle captures an image of a landscape or the like outside the vehicle, and the captured image is displayed on a monitor or the like mounted on the vehicle. A lens unit of the in-vehicle camera is in a state in which the side caused to face an imaging target (object side) is exposed to the outside of the vehicle. Hence, strength, waterproofness, chemical resistance, high-temperature durability, and the like are demanded. In addition, it is necessary to prevent a lens from becoming fogged due to a temperature change.

Patent Literature 1 discloses a lens unit that ensures an airtight state inside a lens barrel in order to prevent the lens from becoming fogged. In such a lens unit, four lenses are aligned with one another in the lens barrel along the optical axis direction. On the object side, sealing performance is achieved by the arrangement of an elastic seal member such as an O-ring between a first lens that is closest to the object side and an inner circumferential surface of the lens barrel. In addition, on an image side (imaging element side), the sealing performance is achieved by an optical filter attached to the lens barrel via an adhesive. In this manner, the airtightness inside the lens barrel is ensured by the seal on the object side and the seal on an image-forming side, and the lens is prevented from becoming fogged.

### CITATION LIST

### Patent Literature

Patent Literature 1: JP 2008-233512 A

### SUMMARY OF INVENTION

### Technical Problem

As described above, by the way, in a case where the first lens is waterproofed by the O-ring (elastic seal member), when the O-ring is caught in the lens barrel or the like and an attachment failure of the O-ring occurs, moisture easily enters an inter-lens space between an outermost surface lens (first lens) and a second lens adjacent to the first lens on the image side in a high-humidity environment, and when the outside air temperature decreases, the back surface of the outermost surface lens on the object side easily becomes fogged by dew condensation.

In addition, the O-ring (elastic seal member) is disposed in a compressed state between the first lens and the inner circumferential surface of the lens barrel. Thus, the first lens receives reaction force by elastic return force of the O-ring. As a result, when the first lens deviates in the optical axis direction, the optical performance is degraded.

Further, it is necessary to incorporate the O-ring into the lens barrel, and thus the number of component parts increases accordingly, and it takes time and effort to attach the O-ring.

The present invention has been made in view of the above circumstances, and has an object to provide a lens unit and a camera module capable of reliably waterproofing a lens space between a first lens and a second lens without use of an O-ring, preventing a back surface of the first lens from becoming fogged, and preventing degradation of optical performance.

### Solution to Problem

In order to address the above issue, according to the present invention, in a lens unit including: a plurality of lenses aligned with each other along an optical axis; and a lens barrel that accommodates and holds the plurality of lenses, in which a first lens located closest to an object side among the plurality of lenses and an optical component adjacent to the first lens on an image side are bonded together to be waterproofed with a low-moisture permeable adhesive.

Examples of the low-moisture permeable adhesive include an acrylic-based adhesive, an epoxy-based adhesive, and an olefin-based adhesive.

In addition, there is a case where the first lens is adjacent to the second lens on the image side, or there is a case where the first lens is adjacent to a spacer for holding a distance in the optical axis direction between the lenses, an optical filter, or the like. Therefore, the above “optical component” includes the second lens, the spacer, and the optical filter.

In the present invention, the first lens located closest to the object side and the optical component adjacent to the first lens on the image side are bonded together to be waterproofed with the low-moisture permeable adhesive, so that moisture hardly enters the inter-lens space between the first lens and the second lens even in a high-humidity environment, without the use of an O-ring. Therefore, even when the outside air temperature becomes lower, the back surface of the first lens can be prevented from becoming fogged due to dew condensation.

In addition, since the O-ring is not used, degradation in the optical performance resulting from the first lens receiving reaction force from the O-ring and deviating in the optical axis direction can be prevented.

In addition, since the O-ring is not used, there is no increase in the number of corresponding component parts, and it does not take time or effort to attach the O-ring.

In addition, in the above configuration of the present invention, the first lens and the lens barrel may be bonded together to be waterproofed with the low-moisture permeable adhesive.

According to such a configuration, the first lens and the lens barrel are bonded together to be waterproofed with the low-moisture permeable adhesive, and thus moisture hardly enters the inside of the lens barrel from between the first lens and the lens barrel, so that the back surface of the first lens can be more reliably prevented from becoming fogged due to dew condensation.

Further, in the above configuration of the present invention, an outer circumferential surface of the first lens and an inner circumferential surface of the lens barrel may be bonded together to be waterproofed with the low-moisture permeable adhesive.

The inner circumferential surface of the lens barrel may be roughened by a sandblasting treatment or the like in order to enhance the adhesive strength of the low-moisture permeable adhesive.

According to such a configuration, the outer circumferential surface of the first lens and the inner circumferential surface of the lens barrel are bonded together to be waterproofed with the low-moisture permeable adhesive, so that moisture that flows from the surface on the object side of the first lens to the outer circumferential surface can be more reliably waterproofed.

Further, in the above configuration of the present invention, an end surface on the image side of the first lens and a surface that intersects with an axial direction of the lens barrel may be bonded together to be waterproofed with the low-moisture permeable adhesive.

The surface that intersects is preferably a surface orthogonal to the axial direction of the lens barrel, but may be inclined relative to the axial direction.

According to such a configuration, the end surface on the image side of the first lens and the surface that intersects with the axial direction of the lens barrel are bonded together to be waterproofed with the low-moisture permeable adhesive. Therefore, even though the low-moisture permeable adhesive that waterproofs between the outer circumferential surface of the first lens and the inner circumferential surface of the lens barrel is damaged by an impact or the like and moisture enters the inside of the lens barrel, the moisture can be reliably prevented from entering the space on the back surface of the first lens.

In addition, the low-moisture permeable adhesives are respectively present in both the axial direction of the lens barrel and the direction that intersects with the axial direction. Therefore, when an impact is applied to the lens unit, either one of the low-moisture permeable adhesives is hardly damaged, and responsive performance to the impact is good.

Further, in the above configuration of the present invention, the low-moisture permeable adhesive agent may have an elastic modulus of 1 MPa to 1000 MPa and a Tg of 40° C. to 60° C.

The elastic modulus indicates an index of how moisture is permeable to the low-moisture permeable adhesive. In a case where the elastic modulus is smaller than 1 MP, the flexibility of the low-moisture permeable adhesive increases and moisture easily permeates, whereas in a case where the elastic modulus exceeds 1000 MP, the low-moisture permeable adhesive becomes too hard and is easily damaged, when receiving an impact. Therefore, the elastic modulus of the low-moisture permeable adhesive is preferably 1 MPa to 1000 MPa.

Tg denotes a glass transition point temperature of the low-moisture permeable adhesive. In a case where Tg exceeds 60° C., the low-moisture permeable adhesive becomes too hard, and the first lens is easily damaged, whereas in a case where Tg is lower than 40° C., the low-moisture permeable adhesive becomes too soft, and moisture easily passes therethrough (waterproof performance is degraded). Therefore, the Tg is preferably 40° C. to 60° C.

According to such a configuration, the first lens located closest to the object side and the second lens can be more reliably waterproofed with the low-moisture permeable adhesive, and in addition, the first lens can be prevented from being damaged.

Further, a camera module according to the present invention includes the above lens unit.

According to such a configuration, the functions and effects of the above-described lens unit are obtainable by the camera module.

### Advantageous Effects of Invention

According to the present invention, the space between the first lens located closest to the object side and the lens barrel can be reliably waterproofed without use of an O-ring, a back surface of the first lens can be prevented from becoming fogged, and in addition, degradation of the optical performance can be prevented.

### BRIEF DESCRIPTION OF DRAWINGS

FIG. 1 illustrates a first embodiment of the present invention, in which FIG. 1(a) is a schematic cross-sectional view of a lens unit, and FIG. 1(b) is a cross-sectional view of main components of a lens unit in a modification.

FIG. 2 is a schematic cross-sectional view of a camera module of the same.

FIG. 3 illustrates a second embodiment of the present invention, in which FIG. 3(a) is a schematic cross-sectional view of a lens unit, and FIG. 3(b) is a cross-sectional view of main components of a lens unit in a modification.

FIG. 4 illustrates a third embodiment of the present invention, in which FIG. 4(a) is a schematic half cross-sectional view of a lens unit, and FIG. 4(b) is a schematic half cross-sectional view of a lens unit in a modification.

FIG. 5 illustrates a fourth embodiment of the present invention, in which FIG. 5(a) is a schematic half cross-sectional view of a lens unit, and FIG. 5(b) is a schematic half cross-sectional view of a lens unit in a modification.

### DESCRIPTION OF EMBODIMENTS

Hereinafter, embodiments of the present invention will be described with reference to the drawings.

Note that a lens unit in the present embodiment to be described below is particularly used for a camera module such as an in-vehicle camera, and is fixed and installed, for example, on an outer surface side of an automobile, and its wiring is drawn into the automobile to be connected with a display or other apparatuses.

Note that a lens unit in the present embodiment to be described below is particularly used for a camera module such as an in-vehicle camera, and is fixed and installed, for example, on an outer surface side of an automobile, and its wiring is drawn into the automobile to be connected with a display or other apparatuses. In addition, hatching is omitted with regard to the lenses in all the drawings.

### First Embodiment

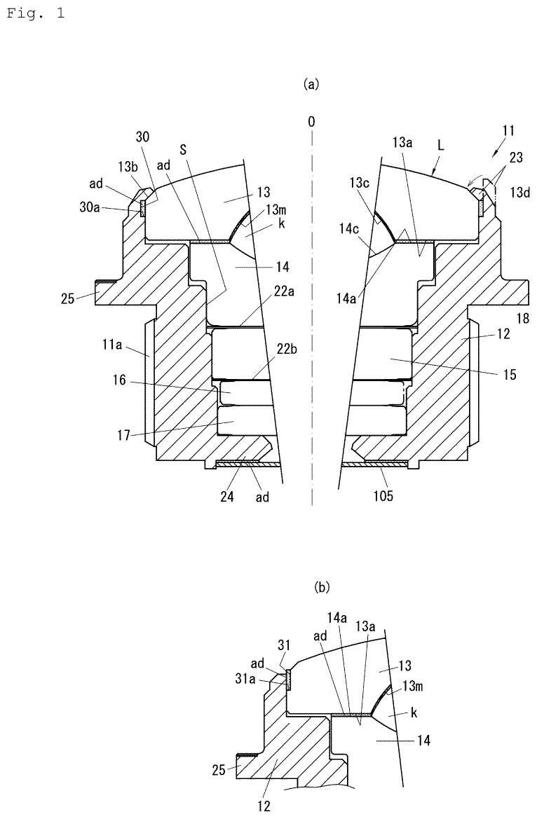

FIG. 1 illustrates a lens unit 11 according to a first embodiment of the present invention. As illustrated in the drawing, the lens unit 11 in the present embodiment includes a lens barrel (barrel) 12 having, for example, a cylindrical shape and being made of resin, a plurality of lenses, which are disposed in an inner accommodation space S in a stepped shape of the lens barrel 12, and which include, for example, five lenses of a first lens 13, a second lens 14, a third lens 15, a fourth lens 16, and a fifth lens 17 from an object side (upper side in FIG. 1), and two diaphragm members 22a and 22b.

Out of the two diaphragm members 22a and 22b, the diaphragm member 22a, which is the first one from the object side is disposed between the second lens 14 and the third lens 15. The diaphragm member 22b, which is a second one from the object side is disposed between the third lens 15 and the fourth lens 16. The diaphragm members 22a and 22b limit transmitted light amounts, and serve as “aperture diaphragms” that determine an F value to be an index of brightness or “light-shielding diaphragms” that shield light beams that cause ghost and light beams that cause aberration. An in-vehicle camera including such a lens unit 11 includes the lens unit 11, a substrate including an image sensor, not illustrated, and an installation member, not illustrated, for installing the substrate on a vehicle such as an automobile.

The plurality of lenses 13, 14, 15, 16, and 17, which are incorporated into the inner accommodation space S to be accommodated and held inside the lens barrel 12, are stacked and disposed in a state in which the respective optical axes are aligned with one another, and the lenses 13, 14, 15, 16, and 17 are aligned with one another along one optical axis O to constitute a group that is a lens group L to be used for imaging. In this case, the first lens 13, which is located closest to the object side, and which constitutes the lens group L, is a spherical glass lens having a convex surface on the object side and a concave surface 13c on the image side, and the second lens 14, which is adjacent to the first lens 13 on the image side, is a resin lens having a concave surface 14c on the object side. The other lenses 15, 16, and 17 including the second lens 14 are resin lenses, but are not limited to this (for example, the first lens 13 may be a resin lens. In a case where the first and second lenses 13 and 14 are made of resin, the difference in linear expansion coefficient between the first lens 13 and the second lens 14 may be, for example, 40×10⁻⁶/K(m) or more).

In the present embodiment, the number of lenses, the materials of the lenses and the lens barrel, and the like can be optionally set in accordance with its application and the like.

In addition, in the present embodiment, two lenses that are the fourth and fifth lenses 16 and 17, which are located on the image side, constitute a cemented lens, but it is not necessary to be the cemented lens. Note that an antireflection film, a hydrophilic film, a water-repellent film, or the like is provided on the surfaces of these lenses 13, 14, 15, 16, and 17, as necessary.

Further, in the present embodiment, unlike the conventional technique, no elastic seal member such as an O-ring is provided in the lens barrel.

In addition, in a state in which the lens group L is incorporated to be accommodated and held inside the inner accommodation space S of the lens barrel 12, a caulking portion 23 is thermally caulked inward in a radial direction in an end portion on the object side (upper end part in FIG. 1) of the lens barrel 12, so that the first lens 13, which is located closest to the object side in the lens group L, is fixed to the end portion on the object side of the lens barrel 12 in the optical axis direction by the caulking portion 23. In this case, in order to accomplish the caulking in a stable manner, a part of the glass lens 13, into which the caulking portion 23 is press-fit, is formed to be a flat portion 13b, which is cut obliquely in a planar shape.

In addition, an inner flange portion 24, which has an opening portion having a diameter smaller than that of the fifth lens 17, is provided in an end portion (lower end part in FIG. 1) on the image side of the lens barrel 12.

The plurality of lenses 13, 14, 15, 16, and 17, which constitute the lens group L, and the diaphragm members 22a and 22b are held and fixed in the optical axis direction in the lens barrel 12 by the inner flange portion 24 and the caulking portion 23.

The inner diameter of the lens barrel 12 gradually decreases from the object side toward an image plane side. In accordance with this, the outer diameters of the lenses 13, 14, 15, 16, and 17 decrease from the object side toward the image plane side. Basically, the outer diameters of the respective lenses 13, 14, 15, 16, and 17 are substantially equal to the inner diameters of the respective parts of the lens barrel 12, by which the lenses 13, 14, 15, 16, and 17 are supported.

Note that on an outer circumferential surface of the lens barrel 12, an outer flange portion 25 having a flange shape to be used in installing the lens barrel 12 onto the in-vehicle camera is provided on the outer circumferential surface of the lens barrel 12.

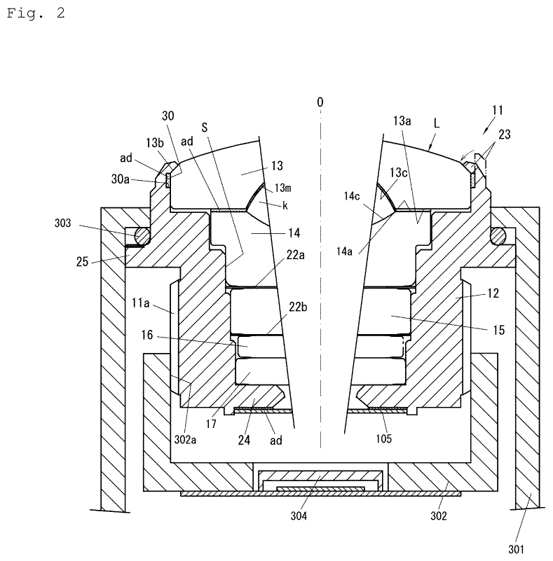

FIG. 2 is a schematic cross-sectional view of a camera module 300, in the present embodiment, including the lens unit 11 illustrated in FIG. 1. As illustrated in the drawing, the camera module 300 includes the lens unit 11, to which a filter 105 is attached.

The camera module 300 includes an upper case (camera case) 301, which is an exterior component, and a mount (base) 302, which holds the lens unit 11. In addition, the camera module 300 includes a seal member 303 and a package sensor (imaging element) 304.

The upper case 301 is a member that exposes an end portion on the object side of the lens unit 11 and that also covers the other parts. The mount 302 is disposed inside the upper case 301, and includes a female screw 302a to be screwed with a male screw 11a of the lens unit 11. The seal member 303 is a member interposed between the inner surface of the upper case 301 and the outer circumferential surface of the lens barrel 12 of the lens unit 11, and is a member for maintaining airtightness inside the upper case 301.

The package sensor 304 is disposed inside the mount 302, and is also disposed in a position for receiving an image of an object to be formed by the lens unit 11. Further, the package sensor 304 includes a CCD, a CMOS, or the like, and converts light that is condensed and that arrives through the lens unit 11 into an electric signal. The converted electric signal is converted into analog data or digital data to be component elements of image data obtained by imaging with the camera.

The filter 105 is bonded with a lower surface of the inner flange portion 24 with a low-moisture permeable adhesive ad.

In the lens unit 11 and the camera module 300 having the above configurations, the first lens 13, which is located closest to the object side, and the second lens 14, which is adjacent to the first lens 13 on the image side, are bonded together to be waterproofed by the low-moisture permeable adhesive ad (hereinafter, referred to as a radial-direction low-moisture permeable adhesive ad, in some cases) so that the inside of an inter-lens space k is hermetically sealed against the outside. The inter-lens space k denotes a space defined between the concave surface 13c, which is formed on the end surface on the image side of the first lens 13, and the concave surface 14c, which is formed on the end surface on the object side of the second lens 14.

As illustrated in FIG. 1(a), an end surface 13a on the image side of the first lens 13 is formed in an annular flat surface, and an end surface 14a on the object side of the second lens 14 is formed in an annular flat surface. The low-moisture permeable adhesive ad is interposed between an inner circumferential surface of the end surface 13a and the end surface 14a, and the first lens 13 and the second lens 14 are bonded together to be waterproofed so that the low-moisture permeable adhesive ad hermetically seals the inside of the inter-lens space k against the outside.

In addition, on the concave surface 13c of the first lens 13, a hydrophilic film 13m is provided so as to cover the entirety of the concave surface 13c. The provision of the hydrophilic film 13m enables prevention of the back side of the first lens 13 of the concave surface 13c from becoming fogged. However, it is assumed that foreign matters adhere to the hydrophilic film 13m, and when UV light is irradiated on the hydrophilic film 13m, the hydrophilic film 13m may be degraded, and the optical performance may be degraded. However, in the present embodiment and second to fourth embodiments to be described later, the first lens 13 and the second lens 14 are bonded together to be waterproofed by the low-moisture permeable adhesive ad, so that the inter-lens space k is hermetically sealed against the outside, and dust is also prevented. Therefore, since no foreign matter adheres to the hydrophilic film 13m, the degradation of the hydrophilic film 13m can be prevented.

In addition, the outer circumferential surface of the first lens 13 and the inner circumferential surface of the lens barrel 12 are bonded together to be waterproofed by the low-moisture permeable adhesive ad (hereinafter, referred to as an axial-direction low-moisture permeable adhesive ad). In the present embodiment, a filling portion 30 to be filled with the low-moisture permeable adhesive ad is provided on the inner circumferential surface of the lens barrel 12, and extends in a circumferential direction. The filling portion 30 is formed by cutting out the inner circumferential surface of the lens barrel 12 into a ring groove shape having a rectangular cross-section, extends in the axial direction of the lens barrel 12, and includes a bottom surface 30a in an end portion on the image side. Such a filling portion 30 is formed on the inner circumferential surface of the lens barrel 12 before the caulking portion 23 is caulked (in FIG. 1, indicated by a two-dot chain line.).

Then, before the caulking portion 23 is caulked, the low-moisture permeable adhesive ad is filled in the filling portion 30, and after the filling, the caulking portion 23 is caulked. Accordingly, the outer circumferential surface of the first lens 13 and the inner circumferential surface of the lens barrel 12 are bonded together to be waterproofed by the axial-direction low-moisture permeable adhesive ad.

Note that also in a case where the first lens 13 and the second lens 14 are bonded together to be waterproofed with the radial-direction low-moisture permeable adhesive ad, before the caulking portion 23 is caulked, the low-moisture permeable adhesive ad is applied to at least one of the end surface 13a of the first lens 13 and the end surface 14a of the second lens 14, and then the first lens 13 overlaps the second lens 14 from above (from the object side), and is incorporated into the lens barrel 12.

When filling the low-moisture permeable adhesive ad into the filling portion 30, the low-moisture permeable adhesive ad is filled from an upper end opening of the filling portion 30. However, the filling portion 30 includes the bottom surface 30a on its lower end, and thus the low-moisture permeable adhesive ad to be filled stops flowing down on the bottom surface 30a. Therefore, the low-moisture permeable adhesive ad can be prevented from entering the inside of the lens barrel 12 across the outer circumferential surface of the first lens 13 or the inner circumferential surface of the lens barrel 12.

In addition, in the present embodiment, only one filling portion 30 is formed. However, a plurality of filling portions 30 may be formed at predetermined intervals in the axial direction of the lens barrel 12, so that the axial-direction low-moisture permeable adhesives ad may be provided at predetermined intervals in the axial direction.

Note that in a case where it is possible to bond and fix the outer circumferential surface of the first lens 13 to the inner circumferential surface of the lens barrel 12 with the axial-direction low-moisture permeable adhesive ad at predetermined axial adhesive strength, the provision of the caulking portion 23 may be omitted.

Further, as a modification, as illustrated in FIG. 2(b), a filling portion 31 into which the axial-direction low-moisture permeable adhesive ad is filled may extend in the circumferential direction, on the outer circumferential surface of the first lens 13. Such a filling portion 31 also includes a bottom surface 31a on the image side. Note that in this modification, the caulking portion 23 is not provided, and the first lens 13 is fixed to the lens barrel 12 with the axial-direction low-moisture permeable adhesive ad. However, the caulking portion 23 may be provided so that the first lens 13 may be fixed by the caulking portion 23.

Examples of the low-moisture permeable adhesive include an acrylic-based adhesive, an epoxy-based adhesive, and an olefin-based adhesive, and the viscosity of these adhesives is preferably equal to or higher than 10 Pa·S. In a case where the viscosity is lower than 10 Pa·S, the axial-direction low-moisture permeable adhesive ad easily drips and flows downward (toward the image side), and it becomes difficult to incorporate the first lens 13 into the lens barrel, while ensuring the waterproof performance between the outer circumferential surface of the first lens 13 and the inner circumferential surface of the lens barrel 12.

The epoxy-based adhesive is higher in adhesive strength than the acrylic-based adhesive, but is inferior in impact resistance. Therefore, when the lens unit 11 is subject to a thermal impact test, the epoxy-based adhesive may be peeled off. For this reason, the acrylic-based adhesive superior in impact resistance to the epoxy-based adhesive is preferably used, but the adhesive strength may be insufficient.

Hence, in a case where the acrylic-based adhesive is used as the axial-direction low-moisture permeable adhesive ad, the inner circumferential surface of the lens barrel 12 and/or the outer circumferential surface of the first lens 13 is preferably roughened by roughening means such as a sandblasting treatment. In addition, in a case where the acrylic-based adhesive is used as the radial-direction low-moisture permeable adhesive ad, the end surface 13a of the first lens 13 and/or the end surface 14a of the second lens 14 is preferably roughened by roughening means such as a sandblasting treatment.

In such a case, root mean square surface roughness Rq is preferably about 0.01 μm to 200 μm.

Further, in a case where the acrylic-based adhesive is used as the low-moisture permeable adhesive ad, the bonding area is preferably kept wide in order to ensure the bonding strength.

The lens barrel 12 made of metal is more superior in adhesion property of an adhesive than the lens barrel 12 made of resin. Hence, in the case of the lens barrel 12 made of metal, the inner circumferential surface or the flat surface 12c of the lens barrel 12 does not have to be roughened in some cases, but roughening is desirable because the adhesion property of the low-moisture permeable adhesive ad is improved.

In addition, the epoxy-based adhesive is higher in adhesive strength than the acrylic-based adhesive. Therefore, the epoxy-based adhesive may be used as the radial-direction low-moisture permeable adhesive ad. With this configuration, there is an advantage that the deviation of the optical axis of the first lens 13 can be prevented.

Furthermore, the epoxy-based adhesive is harder than the acrylic-based adhesive. Therefore, in a case where the epoxy-based adhesive is used as the axial-direction low-moisture permeable adhesive ad, the optical axis of the first lens 13 easily deviates. However, in a case where the acrylic-based adhesive is used as the axial-direction low-moisture permeable adhesive ad, the deviation of the optical axis of the first lens 13 can be prevented.

In addition, in the present embodiment, the low-moisture permeable adhesive ad preferably has an elastic modulus 1 MPa to 1000 MPa and a Tg 40° C. to 60° C.

The elastic modulus indicates an index of how moisture is permeable (moisture permeable performance) of the low-moisture permeable adhesive ad. In a case where the elastic modulus is smaller than 1 MP, the flexibility of the low-moisture permeable adhesive ad becomes higher and moisture easily permeates therethrough, whereas in a case where the elastic modulus exceeds 1000 MP, the low-moisture permeable adhesive ad becomes too hard and the first lens 13 is easily damaged. Therefore, the elastic modulus of the low-moisture permeable adhesive ad is preferably 1 MPa to 1000 MPa.

Tg denotes a glass transition point temperature of the low-moisture permeable adhesive. In a case where Tg exceeds 60° C., the low-moisture permeable adhesive becomes too hard, and the first lens is easily damaged, whereas in a case where Tg is lower than 40° C., the low-moisture permeable adhesive becomes too soft, and moisture easily passes therethrough (waterproof performance is degraded). Therefore, the Tg is preferably 40° C. to 60° C.

Note that in the present embodiment, the first lens 13 is bonded and fixed to the second lens 14 with the radial-direction low-moisture permeable adhesive ad, and the first lens 13 is also bonded and fixed to the lens barrel 12 with the axial-direction low-moisture permeable adhesive ad to ensure the waterproof performance. However, as long as the waterproof performance can be ensured only with the radial-direction low-moisture permeable adhesive ad, the axial-direction low-moisture permeable adhesive ad does not have to be used.

As described heretofore, according to the present embodiment, the first lens 13, which is located closest to the object side, and the second lens 14, which is adjacent to the first lens 13 on the image side, are bonded together to be waterproofed with the low-moisture permeable adhesive ad, so that the inside of the inter-lens space k is hermetically sealed against the outside. Therefore, without the use of an O-ring, moisture hardly enters the inter-lens space k even in a high-humidity environment. Therefore, even when the outside air temperature becomes lower, it is possible to prevent the back surface (concave surface 13c) of the first lens 13 from becoming fogged due to dew condensation.

In addition, since the O-ring is not used, it is possible to prevent degradation in the optical performance resulting from the first lens 13 receiving reaction force from the O-ring and deviating in the optical axis direction.

Further, since the O-ring is not used, there is no increase in the number of corresponding component parts, and it does not take time or effort to attach the O-ring.

In addition, the first lens 13 and the lens barrel 12 are bonded together to be waterproofed with the low-moisture permeable adhesive ad. Therefore, moisture hardly enters the inside of the lens barrel from between the first lens 13 and the lens barrel 12, so that the back surface of the first lens 13 can be more reliably prevented from becoming fogged due to dew condensation.

In addition, the outer circumferential surface of the first lens 13 and the inner circumferential surface of the lens barrel 12 are bonded together to be waterproofed with the axial-direction low-moisture permeable adhesive ad, so that moisture that flows from the surface on the object side of the first lens 13 to the outer circumferential surface can be more reliably waterproofed.

Furthermore, the filling portions 30 and 31, in which the low-moisture permeable adhesive ad is filled, are provided to extend in the circumferential direction on either one of the outer circumferential surface of the first lens 13 or the inner circumferential surface of the lens barrel 12. Therefore, the low-moisture permeable adhesive ad for waterproofing between the outer circumferential surface of the first lens 13 and the inner circumferential surface of the lens barrel 12 can be filled with certainty. In addition, the filling portions 30 and 31 respectively include the bottom surfaces 30a and 31a on lower ends, and the low-moisture permeable adhesive ad to be filled stops flowing down on the bottom surfaces 30a and 31a. Therefore, the low-moisture permeable adhesive ad can be prevented from entering the inside of the lens barrel 12 across the outer circumferential surface of the first lens 13 or the inner circumferential surface of the lens barrel 12.

Further, the first lens 13 is bonded and fixed to the lens barrel 12 with the axial-direction low-moisture permeable adhesive ad, and is fixed to the second lens 14 with the radial-direction low-moisture permeable adhesive ad. When an impact is applied to the lens unit 11, either one of the low-moisture permeable adhesives ad is hardly damaged, and responsive performance to the impact is good.

In addition, the low-moisture permeable adhesive ad has an elastic modulus of 1 MPa to 1000 MPa and a Tg of 40° C. to 60° C., and thus the first lens 13, which is located closest to the object side, and the second lens 14, and the first lens 13 and the lens barrel 12 can be more reliably waterproofed respectively with the low-moisture permeable adhesive ad, and in addition, the first lens 13 can be prevented from being damaged.

### Second Embodiment

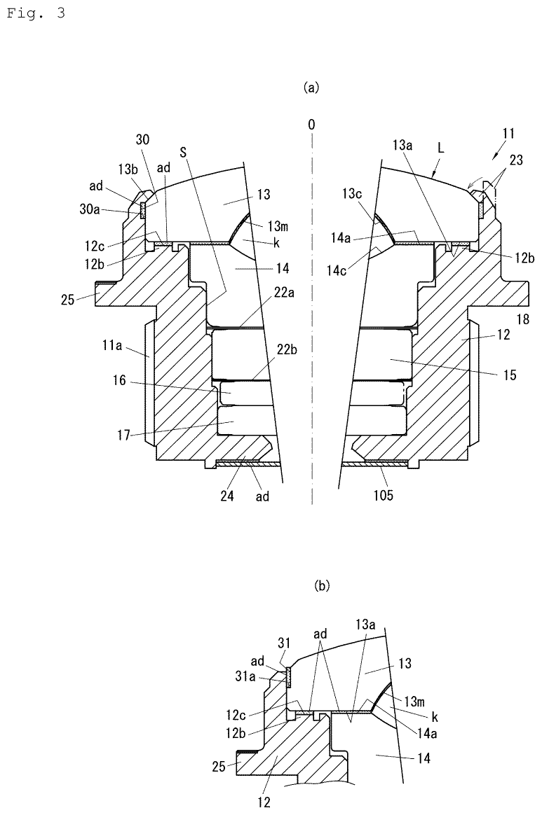

FIG. 3 illustrates a lens unit 11 according to a second embodiment of the present invention. Such a lens unit 11 is different from the lens unit 11 in the first embodiment illustrated in FIG. 1 in that the end surface 13a on the image side of the first lens 13 and a surface that intersects with the axial direction of the lens barrel 12 are bonded together to be waterproofed with a low-moisture permeable adhesive a. Therefore, in the following, this point will be described, and the same components as those in the first embodiment may be denoted by the same reference numerals and the descriptions will be omitted, in some cases.

As illustrated in FIG. 3(a), an inner wall 12b having a cylindrical shape is provided inside the lens barrel 12 on the object side, a tip end surface (upper end surface) of the inner wall 12b is a flat surface 12c, which is orthogonal to (which intersects with) the axial direction of the lens barrel 12, and the flat surface 12c and an outer circumferential portion of the end surface 13a on the image side of the first lens 13 are bonded together to be waterproofed with a low-moisture permeable adhesive ad (hereinafter, referred to as a radial-direction low-moisture permeable adhesive ad, in some cases).

The flat surface 12c faces the end surface 13a on the image side of the first lens 13, and is disposed in the vicinity of the outer circumferential side of the end surface 13a. Then, before the first lens 13 is incorporated into the lens barrel 12, the low-moisture permeable adhesive ad is applied to the flat surface 12c. Then, the first lens 13 is incorporated into the lens barrel 12, so that the end surface 13a on the image side of the first lens 13 and the flat surface 12c of the lens barrel 12 are bonded together to be waterproofed with the radial-direction low-moisture permeable adhesive ad.

In the present embodiment, the axial-direction low-moisture permeable adhesive ad and the radial-direction low-moisture permeable adhesive ad (radial-direction low-moisture permeable adhesive ad that bonds the flat surface 12c of lens barrel 12 and the end surface 13a on the image side of first lens 13 for waterproofing) are provided to be spaced apart from each other, but may be continuously provided to have a letter L-shaped cross-section.

In addition, in a case where the acrylic-based adhesive is used as the radial-direction low-moisture permeable adhesive ad, the flat surface 12c of the lens barrel 12 and/or the end surface 13a on the image side of the first lens 13 is preferably roughened.

According to the present embodiment, the following effects are obtainable, in addition to the effects similar to those in the first embodiment.

The end surface 13a on the image side of the first lens 13 and the flat surface 12c, which is orthogonal to the axial direction of the lens barrel 12, are bonded together to be waterproofed with the radial-direction low-moisture permeable adhesive ad. Therefore, even though the axial-direction low-moisture permeable adhesive ad for waterproofing between the outer circumferential surface of the first lens 13 and the inner circumferential surface of the lens barrel 12 is damaged by an impact or the like and moisture enters the inside of the lens barrel, the moisture can be reliably prevented from entering the space on the back surface of the first lens.

In addition, the first lens 13 is bonded to be waterproofed with one axial-direction low-moisture permeable adhesive ad and two radial-direction low-moisture permeable adhesives ad, and thus waterproofing effects and the bonding strength are enhanced.

### Third and Fourth Embodiments

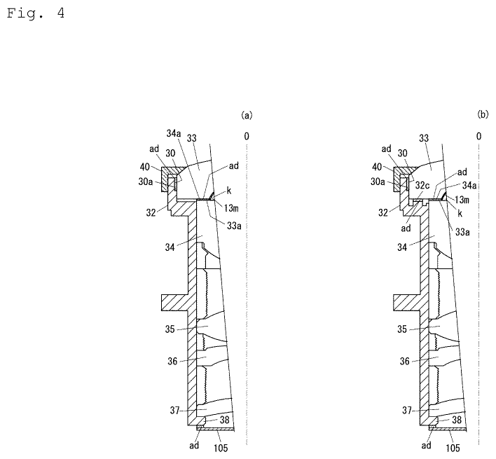

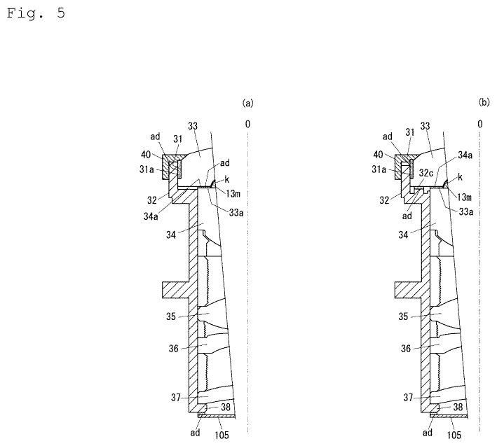

FIG. 4 is a half cross-sectional view illustrating a lens unit according to a third embodiment of the present invention, and FIG. 5 is a half cross-sectional view illustrating a lens unit according to a fourth embodiment of the present invention.

In the first and second embodiments described above, the case where the lens barrel 12 made of resin is used has been described as an example. However, in the third and fourth embodiments, a lens barrel 32 made of metal is used. Similarly to the lens barrel 12 made of resin, a first lens 33, a second lens 34, a third lens 35, a fourth lens 36, and a fifth lens 37 are incorporated from the object side (upper side in FIGS. 4 and 5) in the lens barrel 32 made of metal.

In addition, a filter 105 is bonded to a lower surface of an inner flange portion 38 with a low-moisture permeable adhesive ad.

In the case of using the lens barrel 32 made of metal, in the third embodiment, as illustrated in FIG. 4(a), the first lens 33, which is located closest to the object side, and the second lens 34, which is adjacent to the first lens 33 on the image side, are bonded together to be waterproofed with the low-moisture permeable adhesive ad, so that the inside of the inter-lens space k is hermetically sealed against the outside. That is, an end surface 33a on the image side of the first lens 33 and an end surface 34a on the object side of the second lens 34 are bonded together to be waterproofed with the radial-direction low-moisture permeable adhesive ad.

In addition, a filling portion 30 having a bottom surface 30a is provided on an inner circumferential surface of the lens barrel 32, and extends in the circumferential direction. The low-moisture permeable adhesive ad is filled in the filling portion 30, so that an outer circumferential surface of the first lens 33 and an inner circumferential surface of the lens barrel 32 are bonded together to be waterproofed with the axial-direction low-moisture permeable adhesive ad.

Further, a cap (press member) 40 is screwed and fastened to an end portion (upper end portion) on the object side of the lens barrel 32, so that the first lens 33 is fixed to an end portion on the object side of the lens barrel 32 in the optical axis direction.

Note that as long as it is possible to bond and fix the outer circumferential surface of the first lens 33 to the inner circumferential surface of the lens barrel 32 with the axial-direction low-moisture permeable adhesive ad at predetermined axial adhesive strength, the provision of the cap 40 may be omitted.

In addition, as in a modification illustrated in FIG. 4(b), the end surface 33a on the image side of the first lens 33 and a flat surface 32c, which is orthogonal to (which intersects with) the axial direction of the lens barrel 32, may be bonded together to be waterproofed with the radial-direction low-moisture permeable adhesive ad.

Also in this case, as long as it is possible to bond and fix the outer circumferential surface of the first lens 33 to the inner circumferential surface of the lens barrel 12 with the axial-direction low-moisture permeable adhesive ad at predetermined axial adhesive strength, the provision of the cap 40 may be omitted.

In addition, in the fourth embodiment, as illustrated in FIG. 5(a), the first lens 33, which is located closest to the object side, and the second lens 34, which is adjacent to the first lens 33 on the image side, are bonded together to be waterproofed with the low-moisture permeable adhesive ad, so that the inside of the inter-lens space k is hermetically sealed against the outside. That is, an end surface 33a on the image side of the first lens 33 and an end surface 34a on the object side of the second lens 34 are bonded together to be waterproofed with the radial-direction low-moisture permeable adhesive ad.

Further, a filling portion 31, in which the low-moisture permeable adhesive ad is filled, may extend in the circumferential direction on the outer circumferential surface of the first lens 33. Such a filling portion 31 also includes a bottom surface 31a on the image side. The low-moisture permeable adhesive ad is filled in the filling portion 31, so that the outer circumferential surface of the first lens 33 and the inner circumferential surface of the lens barrel 32 are bonded together to be waterproofed with the axial-direction low-moisture permeable adhesive ad.

In addition, as illustrated in a modification of FIG. 5(b), the end surface 33a on the image side of the first lens 33 and the flat surface 32c, which is orthogonal to (which intersects with) the axial direction of the lens barrel 32, may be bonded together to be waterproofed with the radial-direction low-moisture permeable adhesive ad.

Also in this case, as long as it is possible to bond and fix the outer circumferential surface of the first lens 33 to the inner circumferential surface of the lens barrel 12 with the axial-direction low-moisture permeable adhesive ad at predetermined axial adhesive strength, the provision of the cap 40 may be omitted.

Also in the third and fourth embodiments, the effects similar to those in the first and second embodiments are obtainable.

Note that in the first to fourth embodiments described above, the lens unit 11 including the second lens 14, which is adjacent to the first lens 13 on the image side, and the lens unit including the second lens 34, which is adjacent to the first lens 33 on the image side, have been described. However, instead of this, the present invention is also applicable to a lens unit including a spacer or an optical component such as an optical filter, which is adjacent to the first lenses 13 and 33 on the image side. In addition, the present invention is not limited to the above-described embodiments, and various modifications can be made without departing from the gist of the present invention. For example, in the present invention, the shapes and the like of the lens, the lens barrel, and the like are not limited to those in the above-described embodiments. In addition, a part or all of the above-described embodiments may be combined, or a part of the configuration may be omitted from one of the above-described embodiments without departing from the gist of the present invention.

### REFERENCE SIGNS LIST

11 Lens unit
12, 32 Lens barrel
12c, 32c Flat surface (surface that intersects with axial direction of lens barrel)
13, 33 First lens
14, 34 Second lens
13a, 33a End surface on image side of first lens
14a, 34a End surface on object side of second lens
15, 16, 17, 34, 35, 36, 37 Lens
30, 31 Filling portion
ad Low-moisture permeable adhesive

1. A lens unit comprising: a plurality of lenses aligned with each other along an optical axis; and a lens barrel that accommodates and holds the plurality of lenses, wherein
a first lens located closest to an object side among the plurality of lenses and an optical component adjacent to the first lens on an image side are bonded together to be waterproofed with a low-moisture permeable adhesive.

2. The lens unit according to claim 1, wherein the first lens and the lens barrel are bonded together to be waterproofed with the low-moisture permeable adhesive.

3. The lens unit according to claim 2, wherein an outer circumferential surface of the first lens and an inner circumferential surface of the lens barrel are bonded together to be waterproofed with the low-moisture permeable adhesive.

4. The lens unit according to claim 2, wherein an end surface on the image side of the first lens and a surface that intersects with an axial direction of the lens barrel are bonded together to be waterproofed with the low-moisture permeable adhesive.

5. The lens unit according to claim 1, wherein the low-moisture permeable adhesive has an elastic modulus of 1 MPa to 1000 MPa and a Tg of 40° C. to 60° C.

6. A camera module comprising the lens unit according to claim 1.
